(19) United States
(12) Patent Application Publication
(10) Pub. No.: US 2016/0164051 A1
(43) Pub. Date: Jun. 9, 2016

(54) SECONDARY BATTERY AND BATTERY PACK INCLUDING THE SAME

(71) Applicant: SAMSUNG SDI CO., LTD., Yongin-si (KR)

(72) Inventors: Man-Sik CHO, Yongin-si (KR); So-Ra LEE, Yongin-si (KR)

(21) Appl. No.: 14/741,666

(22) Filed: Jun. 17, 2015

(30) Foreign Application Priority Data
Dec. 8, 2014 (KR) 10-2014-0175200

(51) Int. Cl. H01M 2/02; H01M 2/20

(52) U.S. Cl. CPC H01M 2/021; H01M 2/024; H01M 2/204; H01M 2/206; H01M 2220/30; H01M 2220/20

(57) ABSTRACT

A secondary battery includes a unit cell including a first electrode tab and a second electrode tab, a cell holder accommodating the unit cell, the first electrode tab and the second electrode tab being exposed by the cell holder, a first clip fixed to the cell holder, the first electrode tab being detachably inserted into the first clip, and a second clip fixed to the cell holder, the second electrode tab being detachably inserted into the second clip.

### CROSS-REFERENCE TO RELATED APPLICATION

Korean Patent Application No. 10-2014-0175200, filed on Dec. 8, 2014, in the Korean Intellectual Property Office, and entitled: “Secondary Battery and Battery Pack Including The Same,” is incorporated by reference herein in its entirety.

### BACKGROUND

1. Field

The present disclosure relates to a secondary battery and a battery pack including the same.

2. Description of the Related Art

A secondary battery is a battery repeatedly performing charging and discharging. A small-capacity secondary battery may be used for portable compact electronic apparatuses, e.g., a mobile phone, a notebook computer, and a camcorder, and a large-capacity secondary battery may be used as a power supply for driving a motor, e.g., of a hybrid vehicle, an electric vehicle, and the like.

The secondary battery may be included in a battery pack, in which a plurality of unit cells is connected in series or in parallel for high output or high capacity as necessary. The unit cell includes an electrode assembly with a positive electrode and a negative electrode provided on opposite surfaces of a separator, a case for accommodating the electrode assembly, and an electrode terminal electrically connected to the electrode assembly and extended outside of the case.

### SUMMARY

An exemplary embodiment provides a secondary battery, including a unit cell including a first electrode tab and a second electrode tab, a cell holder accommodating the unit cell, the first electrode tab and the second electrode tab being exposed by the cell holder, a first clip fixed to the cell holder, the first electrode tab being detachably inserted into the first clip, and a second clip fixed to the cell holder, the second electrode tab being detachably inserted into the second clip.

The unit cell may include an electrode assembly including a first electrode, a second electrode, and a separator interposed between the first electrode and the second electrode, and a case in which the electrode assembly is sealed with an electrolyte, and the first electrode tab may be electrically connected with the first electrode and extended to the outside of the case, and the second electrode tab may be electrically connected with the second electrode and extended to the outside of the case.

The cell holder may include a holder frame configured to surround a border of the unit cell, and a clip fixing part extended to the outside from the holder frame, in which the first clip is fixed to a side of the clip fixing part frame facing the first electrode tab, and the second clip is fixed to a side of the clip fixing part facing a second electrode tab.

Each of the first electrode tab and the second electrode tab may be extended to the outside of the holder frame, and is extended in a direction in which the clip fixing part is extended.

The first electrode tab and the second electrode tab may be extended in a space between a part, to which the first clip of the clip fixing part is fixed, and a part, to which the second clip of the clip fixing part is fixed.

The first clip and the second clip may be fixed to the clip fixing part while facing each other.

The first clip and the second clip may include: pairs of extended parts extended while having a gradually decreased interval and then having a gradually increased interval again, so that the first and second electrode tabs are fixed to the first and second clips, and a connection part configured to connect ends of the pair of extended parts and fixed to the clip fixing part.

The holder frame may include a plurality of frame parts, which are coupled to each other to form the holder frame. Further, a first frame part may surround a part of the unit cell and be extended from at least a part adjacent to the first electrode tab to an opposite side of the part, and a second frame part may surround a part of the unit cell at the opposite side of the first frame part, and be extended from at least a part adjacent to the second electrode tab to an opposite side of the part.

The clip fixing part may include a first clip fixing part extended from the first frame part to the outside, and to which the first clip is fixed, and a second clip fixing part extended from the second frame part to the outside, and to which the second clip is fixed.

Another exemplary embodiment provides a battery pack, including a plurality of secondary batteries, and a plurality of conductive bars configured to connect the plurality of secondary batteries in parallel.

The secondary battery may include a unit cell including a first electrode tab and a second electrode tab, a cell holder, in which the unit cell is accommodated so that the first electrode tab and the second electrode tab are exposed, a first clip fixed to the cell holder, and into which the first electrode tab is detachably inserted, and a second clip fixed to the cell holder, and into which the second electrode tab is detachably inserted.

Each of the first clip and the second clip may include a bar contact part which is in contact with the conductive bars, and a tab contact part bent and extended from the bar contact part, and into which a corresponding electrode tab between the first electrode tab and the second electrode tab is inserted, and the tab contact part may include a plurality of extended part extended while having a gradually decreased interval and then having a gradually increased interval again, so that the corresponding electrode tab is fixed to a space of the tab contact part.

The conductive bar may include a plurality of clip contact parts accommodated in corresponding bar contact parts among the plurality of bar contact parts, and a connection bar configured to electrically connect the plurality of clip contact parts.

The connection bar may be extended in a direction crossing the plurality of bar contact parts, and the clip contact part may be extended from the connection bar onto the bar contact part.

Another exemplary embodiment provides a cell holder accommodating a unit cell of a secondary battery, the cell holder including a first clip extending from a frame, a first electrode tab of the unit cell being detachably inserted into the first clip, and a second clip extending from the frame, a second electrode tab of the unit cell being detachably inserted into the second clip.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view of a secondary battery according to an exemplary embodiment.

FIG. 2 illustrates an exploded perspective view of FIG. 1.

FIG. 3 illustrates an exploded perspective view of a secondary battery according to another exemplary embodiment.

FIG. 4 illustrates a perspective view of a battery pack according to an exemplary embodiment.

FIG. 5 illustrates a partial enlarged perspective view of FIG. 4.

FIG. 6 illustrates a cross-sectional view taken along line I-I of FIG. 5.

FIG. 7 illustrates an exploded perspective view of an embodiment of a unit cell shown in FIGS. 2 and 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another element or substrate, it can be directly on the other element or substrate, or intervening elements may also be present. In addition, it will also be understood that when an element is referred to as being “between” two elements, it can be the only element between the two elements, or one or more intervening elements may also be present. Further, it will also be understood that when one element is referred to as being “connected to” another element, the other element can be directly coupled to or connected to the first constituent element, or intervening elements may also be present. Further, an irrelevant part to the present disclosure may be omitted to clarify the description of the example embodiments. Like reference numerals refer to like elements throughout.

Any battery capable of being charged or discharged is acceptable as a secondary battery mentioned in the present disclosure.

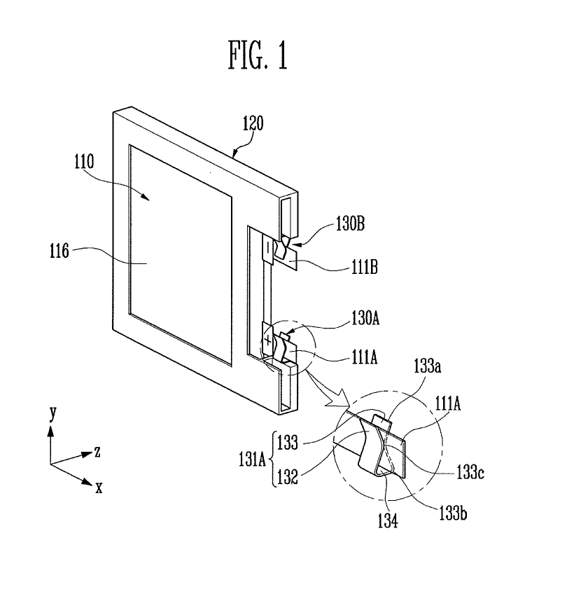

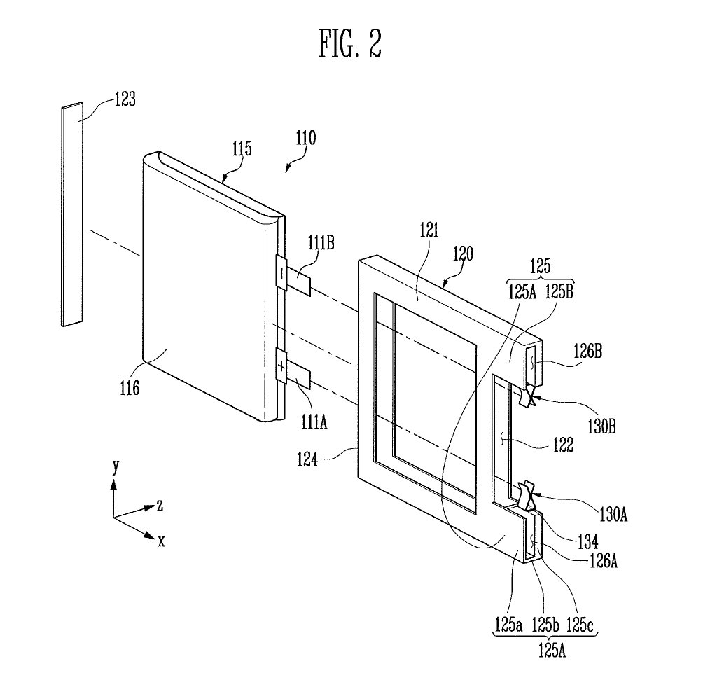

FIG. 1 illustrates a perspective view of a secondary battery according to an exemplary embodiment, and FIG. 2 is an exploded perspective view of the exemplary embodiment of FIG. 1. Referring to FIGS. 1-2, a secondary battery according to the exemplary embodiment may include a unit cell 110, a cell holder 120, and first and second clips 130A and 130B.

Referring to FIG. 2, in the unit cell 110, an electrode assembly body including a separator interposed between a first electrode and a second electrode is sealed in a case 115 together with an electrolyte. The unit cell 110 has a flat shape with a predetermined thickness, and a first electrode tab 111A and a second electrode tab 111b are provided at a same side.

The first electrode tab 111A is electrically connected with the first electrode and is extended to the outside of the case 115. The second electrode tab 111B is electrically connected with the second electrode and is extended to the outside of the case 115, in such a manner that the second electrode tab 111B and the first electrode tab 111A are extended in the same direction. In this case, as illustrated in the drawings, the first electrode tab 111A and the second electrode tab 111B may be extended in parallel. The first and second electrode tabs 111A and 111B may be formed as conductive bars shaped like flat bands or straps, and are formed with sufficient thicknesses to be firmly fixed to the first and second clips 130A and 130B, which will be described below, while being engaged with the first and second clips 130A and 130B.

A polarity of the first electrode is different from a polarity of the second electrode, and in the present exemplary embodiment, it is illustrated that the first electrode is a positive electrode and the second electrode is a negative electrode. However, embodiments are not limited thereto, e.g., the first electrode may be a negative electrode and the second electrode may be a positive electrode.

As long as a cell is capable of reacting with an electrolyte and generating electrochemical energy, the cell is acceptable as the unit cell 110, e.g., the unit cell 110 may be a lithium polymer cell or a lithium ion cell.

The cell holder 120 detachably accommodates the unit cell 110. When the unit cell 110 is connected and fixed to the first and second clips 130A and 130B, the first and second clips 130A and 130B support the unit cell 110. The cell holder 120 may include a holder frame 121 and a clip fixing part 125. The holder frame 121 is a member which is formed by a frame having an appropriately quadrangular border, and at least partially surrounds the unit cell 110 to protect the unit cell 110. The holder frame 121 may be formed of an insulating material. Further, the holder frame 121 may be formed of a plastic material and injection molded.

Referring to FIGS. 1 and 2, the holder frame 121 surrounds at least two borders among four borders of the case 115 of the unit cell 110, and an electrode tab through-hole 122, through which the first electrode tab 111A and the second electrode tab 111B are exposed to the outside, is formed at one of the parts corresponding to the two remaining borders. Further, an opening 124 for inserting the unit cell 110 into the holder frame 121 is formed at an opposite side of the electrode tab through-hole 122. For example, the unit cell 110 may be inserted through the opening 124 and pushed toward the electrode tab through-hole 122 to be surrounded by the holder frame 121.

The holder frame 121 may be formed, e.g., defined, by a frame having an approximate quadrangular border, e.g., shape, so that when the unit cell 110 is accommodated in the holder frame 121, a wide side surface 116 of the case 115 is exposed. However, the holder frame 121 is not limited thereto, and various shapes of the holder frame may be adopted as long as the holder frame accommodates and protects the unit cell 110, e.g., the holder frame may be configured so as to completely cover the side surface 116 of the case and prevent the side surface 116 from being viewed, or so as to be provided with a plurality of through-holes to partially expose the side surface 116 of the case.

The clip fixing part 125 is on a same side of the holder frame 121 as the electrode tab through-hole 122, and is extended from the holder frame 121 to the outside, i.e., away from the holder frame 121. The clip fixing part 125 is a part for fixing the first and second clips 130A and 130B to the cell holder 120.

In detail, the clip fixing part 125 includes a first clip fixing part 125A, to which the first clip 130A is fixed, and a second clip fixing part 125B, to which the second clip 130B is fixed. The first clip fixing part 125A and the second clip fixing part 125B are formed at both ends of the electrode tab through-hole 122, respectively, and are extended in the same direction as the direction in which the first and second electrode tabs 111A and 111B are extended, e.g., along the x-axis. For example, the first and second clip fixing parts 125A and 125B may be spaced apart from each other along the y-axis at opposite ends of the electrode tab through-hole 122.

Referring to FIGS. 1 and 2, the first and second clip fixing parts 125A and 125B are formed by a plurality of walls extended from external surfaces of the holder frame 121, so that spaces 126A and 126B are formed within the walls, and the walls to which the first and second clips 130A and 130B are fixed are formed to be relatively thick, and the remaining walls are formed to be relatively thin. For example, as illustrated in FIG. 2, the first clip fixing part 125A may include first, second, and third walls 125a, 125b, and 125c, respectively, that are arranged to define the empty space 126A, e.g., the third wall 125c may be thicker than each of the first and second walls 125a and 125b to support the first clip 130A thereon. The empty spaces 126A and 126B formed at the first clip fixing part 125A and the second clip fixing part 125B, respectively, may be utilized as gas discharge paths.

Referring to FIG. 2, the holder frame 121 may further include an auxiliary fixing member 123 for covering the opening 124, which is formed so as to accommodate the unit cell 110 in the holder frame 121, as necessary. The auxiliary fixing member 123 is detachably coupled to the opening 124 in the holder frame 121. For example, the auxiliary fixing member 123 may be fixed to the holder frame 121 by a fastening means, e.g., a screw, and the auxiliary fixing member 123 may be provided with a hook attachable to a recess in a main body of the holder frame 121, so that the auxiliary fixing member 123 may be fitted, e.g., affixed, to the holder frame 121. However, the present disclosure is not limited thereto, e.g., the auxiliary fixing member 123 may also be fixedly coupled to the holder frame 121.

The auxiliary fixing member 123 may be omitted, and instead of the auxiliary fixing member fitted to the opening, a fixing bar, e.g., shaped like a bar and horizontally installed to cover a part of the opening 124, may also provided. The fixing bar may be provided so as to fix the secondary batteries when a plurality of secondary batteries is stacked for manufacturing the battery pack.

The first and second clips 130A and 130B are members into which the first and second electrode tabs 111A and 111B are inserted to be fixed, respectively. Further, the first and second clips 130A and 130B are formed of a conductive material, and are electrically connected with the first and second electrode tabs 111A and 111B, respectively. Accordingly, the first and second clips 130A and 130B are electrically connected with the first electrode and the second electrode in the electrode assembly through the first and second electrode tabs 111A and 111B, respectively.

Referring to FIG. 1, the first clip 130A includes a first tab contact part 131A, into which the first electrode tab 111A is inserted to be fixed, and a connection part 134 extended from the first tab contact part 131A to be fixed to the first clip fixing part 125A. The second clip 130B includes a second tab contact part, into which the second electrode tab 111B is inserted to be fixed, and a second connection part extended from the second tab contact part to be fixed to the second clip fixing part 125B. The first and second clips 130A and 130B have the same shape and different disposition directions, so that only a shape of the first clip will be described, and a detailed description of a shape of the second clip will be omitted hereinafter.

As illustrated in FIG. 1, in the first tab contact part 131A, plate-shaped extended parts 132 and 133 are extended while having an interval at a first end 133a, gradually become close to each other at point 133c, and then have a gradually increased interval toward a second end 133b, i.e., an end opposite the first end 133a. For example, as illustrated in FIG. 1, the extended parts 132 and 133 may have wave-shapes symmetrically arranged as mirror images of each other, so the first ends 133a of the extended parts 132 and 133 are spaced apart from each other along the z-axis, the second ends 133b of the extended parts 132 and 133 are spaced apart and connected to each other by a flat plate-shaped connection part 134 along the x-axis, and respective points(portions) 133c of the extended parts 132 and 133 extend toward each other along the z-axis. The extended parts 132 and 133 are connected with each other by the connection part 134 at the second end 133b to be fixed to the first clip fixing part 125A.

The two extended parts 132 and 133 are formed so that an interval at the points 133c, i.e., at which the two extended parts 132 and 133 are closest to each other, is smaller than at least a thickness of the first electrode tab 111A, e.g., the two extended parts 132 and 133 may be in contact with each other at the point 133c. Further, the two extended parts 132 and 133 may be formed of an elastic member for firmly fixing the first electrode tab 111A when the first electrode tab 111A is inserted between the two extended parts 132 and 133.

The two extended parts 132 and 133 are connected with each other via the connection part 134, as illustrated in FIG. 1. Referring to FIG. 2, the connection part 134 is formed in such a manner that the extended parts 132 and 133 are bent inwardly and connected with each other via the connection part 134, and is shaped like a flat plate. The connection part 134 is fixed to a surface of the first clip fixing part 125A facing the first electrode tab 111A, i.e., fixed to an upper surface of the third wall 125c, to fix the first tab contact part 131A to the cell holder 121. Similarly, the connection part 134 of the second clip 130B is fixed to a surface of the second clip fixing part 125B facing the second electrode tab 111B to fix the second tab contact part to the cell holder.

Although not illustrated, the connection part 134 may be fixed to the first clip fixing part 125A by various methods. For example, a recess may be formed in the first clip fixing part 125A, and the connection part 134 may be inserted into and fixed to the recess. In another example, the connection part 134 may be fixed to the recess by a separate fastening means, e.g., a screw. Any convenient method may be adopted as long as the fixing method fixes a conductive member to an insulating member.

The connection parts 134 of the first and second clips 130A and 130B having the aforementioned shape are fixed to the first and second clip fixing parts 125A and 125B, respectively. In this case, the first clip 130A and the second clip 130B are disposed in a facing shape to be fixed to the first and second clip fixing parts 125A and 125B, respectively. Referring to FIG. 1, the first clip and the second clip 130A and 130B are disposed in the first clip fixing part 125A and the second clip fixing part 125B, respectively, while the parts of the pair of extended parts 132 and 133, which are spaced apart from each other in a V shape at an interval, face each other.

The first electrode tab 111A and the second electrode tab 111B pass through the electrode tab through-hole 122 and are exposed to the outside through the cell holder 121, and are extended between the first clip fixing part 125A and the second clip fixing part 125B. Further, the first electrode tab 111A is extended to be adjacent to the first clip fixing part 125A to pass through a space between the pair of extended parts 132 and 133 of the first clip 130A. The second electrode tab 111B is extended to be adjacent to the second clip fixing part 125B to pass through a space between the extended parts of the second clip 130B.

As described above, the first and second electrode tabs 111A and 111B are engaged with and fixed to the first and second clips 130A and 130B, respectively. As described above, the unit cell 110 is accommodated in and fixed to the cell holder 120 without welding, so that the unit cell 110 may be separately accommodated in the cell holder 121. Further, welding is not required for inserting and fixing the first and second electrode tabs 111A and 111B to the first and second clips 130A and 130B, so that poor welding may be prevented.

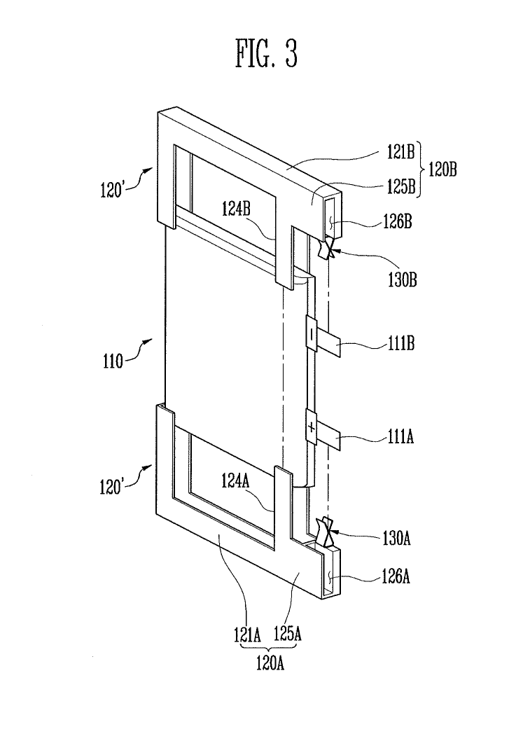

FIG. 3 illustrates an exploded perspective view of a secondary battery according to another exemplary embodiment. A secondary battery according to another exemplary embodiment will be described with reference to FIG. 3.

Referring to FIG. 3, a secondary battery may include the unit cell 110, a cell holder 120′, and the first and second clips 130A and 130B. Configurations and functions of the unit cell 110 and the first and second clips 130A and 130B are the same as those of the aforementioned exemplary embodiment, so that detailed descriptions thereof will not be repeated.

The cell holder 120′ is configured so that a plurality of holder frames are coupled to each other to surround a border, e.g., an edge, of the unit cell 110, and includes a first holder part 120A and a second holder part 120B. Referring to FIG. 3, the first holder part 120A and the second holder part 120B are formed so that the cell holder 120′ is separated toward a first electrode tab side and a second electrode tab side to fix the first and second electrode tabs 111A and 111B, respectively. In other words, as illustrated in FIG. 3, the first holder part 120A and the second holder part 120B may be combinable into the cell holder 120′ to affix the first and second electrode tabs 111A and 111B.

In detail, the first holder part 120A includes a first frame part 121A and a first clip fixing part 125A, and the second holder part 120B includes a second frame part 121B and a second clip fixing part 125B. The first frame part 121A and the second frame part 121B surround borders of the unit cell at one border of the unit cell 110 and the opposite border, respectively. A general shape of the holder frame 121′ in an assembled state, i.e., when the first frame part 121A and the second frame part 121B are coupled to the unit cell 110, is the same as that of the holder frame 121 coupled to the auxiliary fixing member 123 of FIG. 2. In other words, the holder frame 121 in the state where the first frame part 121A is coupled to the second frame part 121B is a quadrangular frame having a shape surrounding three borders, e.g., edges, among four borders of the unit cell 110, and the first and second electrode tabs 111A and 111B are exposed at the one remaining border of the unit cell 110, so that an electrode tab through-hole 122 is formed at a position corresponding to the one remaining border of the unit cell 110. Further, the first clip fixing part 125A and the second clip fixing part 125B are extended from the first and second frame parts and formed at both ends of the electrode tab through-hole 122, and detailed configurations and functions thereof are the same as those of the aforementioned exemplary embodiment, so that a detailed description thereof will not be repeated.

The first frame part 121A and the second frame part 121B will be described in detail with reference to FIG. 3. The first frame part 121A may have an approximate H shape to extend from a center of the border of the unit cell 110 at a first side, i.e., a side at which the first electrode tab 111A is provided, to a center of the border at a second side, i.e., an opposite side. The second frame part 121B is a frame having an approximate H shape extending from a center of the border of the unit cell at the first side, i.e., at which the second electrode tab 111B is provided, to a center of the border at the opposite side. That is, the shapes of the first and second frame parts 121A and 121B may be mirror images of each other. Further, as described above, the electrode tab through-hole 122 is formed in the holder frame 121′, so that a first frame connection part 124A extended along a side surface 116 of the border of the first electrode tab side is formed at the first frame part 121A (that is one of the two separated frame parts of the holder frame 121′), and a second frame connection part 124B extended along the side surface 116 of the border of the second electrode tab side is formed at the first frame part 121A, so that the first and second frame connection parts 124A and 124B form together the electrode tab through-hole 122 while meeting, e.g., contacting, each other.

A structure, in which the unit cell 110 is accommodated in the first holder part 120A and the second holder part 120B, will be described in detail with reference to FIG. 3. However, for convenience of description, a side close to the first electrode tab 111A of the unit cell 110 will be described as a lower part, and a side close to the second electrode tab 111B of the unit cell 110 will be described as an upper part, but a concept of the upper part and the lower part may be varied according to the positions of the first and second electrode tabs as a matter of course. That is, based on a line for dividing the unit cell 110 between the first electrode tab 111A and the second electrode tab 111B into two parts, a part under the line is indicated as a lower part, and a part above the line is indicated as an upper part.

The first holder part 120A is coupled at one side of the unit cell 110, in such a manner that the first holder part 120A is coupled at a lower part of the unit cell 110, and the second holder part 120B is coupled at an opposite side relative to the first holder part 120A, i.e., the second holder part 120B is coupled at an upper part of the unit cell 110. In this case, the first electrode tab 111A is inserted into and fixed to the first clip 130A on the first holder part 120A.

As described above, the tab contact part 131A of the first clip 130A includes two extended parts 132 and 133, and the two extended parts 132 and 133 are formed so that first ends of the two extended parts 132 and 133 are spaced apart from each other in a V shape, so that the first electrode tab 111A is easily inserted into the first tab contact part 131A. Similarly, the second tab contact part of the second clip 130B are formed so that first ends of the second tab contact part are spaced apart from each other in a V shape, so that the second electrode tab 111B is easily inserted into the second tab contact part of the second clip 130B.

According to an aspect of the aforementioned configuration, the cell holder 120′ includes a plurality of holder frames disposed to face each other, so that the cell holder 120′ may be coupled to the unit cell 110 from opposite directions. As such, the electrode tabs 111A and 111B are fixed to the first clip 130A and the second clip 130B, which are disposed to have intervals toward the first electrode tab and the second electrode tab, respectively, so that the unit cell 110 is easily detachable. Further, similar to the aforementioned exemplary embodiment, the unit cell 110 is directly accommodated in and fixed to the cell holder 120′ by insertion, so that welding is not required, and thus poor welding may be prevented or substantially minimized.

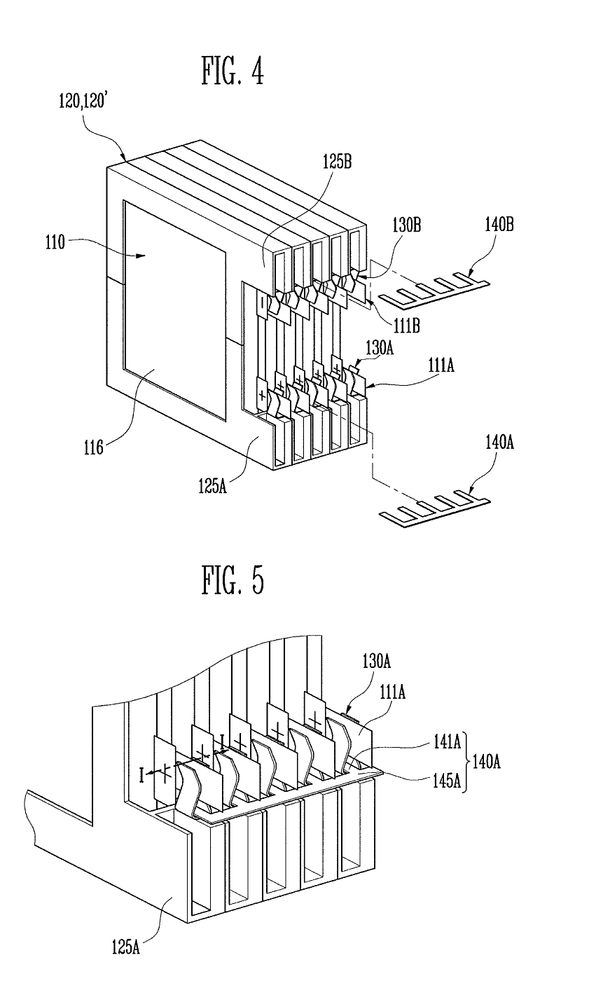

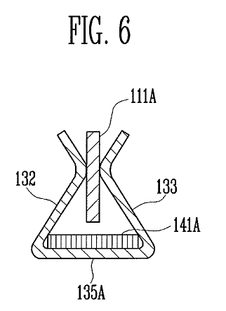

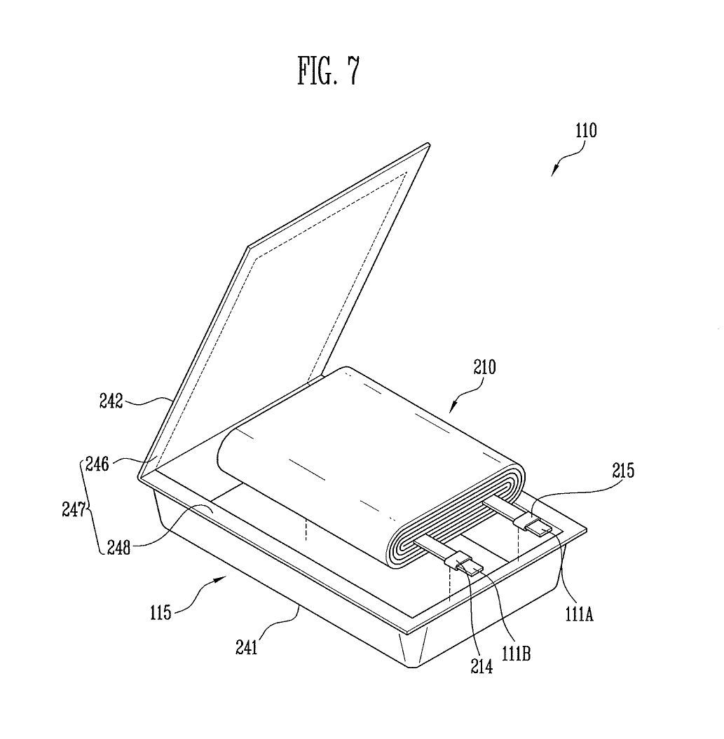

FIG. 4 illustrates a perspective view of a battery pack according to an exemplary embodiment, FIG. 5 illustrates a partial enlarged perspective view of the exemplary embodiment of FIG. 4, and FIG. 6 illustrates a cross-sectional view taken along line I-I of FIG. 5. A battery pack according to an exemplary embodiment will be described in detail with reference to FIGS. 4 to 6. However, FIG. 4 illustrates the cell holder 120′ of the exemplary embodiment, in which the holder frames are separated, but the cell holder 120 of the exemplary embodiment, in which the holder frame is integrally formed, may also be applicable as a matter of course.

Referring to FIGS. 4-6, in the battery pack according to the exemplary embodiment, the secondary batteries according to the aforementioned exemplary embodiment are connected in parallel, and the battery pack includes a plurality of secondary batteries and a plurality of conductive bars 140A and 140B for connecting the secondary batteries in parallel. Each of the plurality of secondary batteries includes the unit cell 110, the cell holder 120 (or 120′), in which the unit cell 110 is accommodated, and first and second clips 130A and 130B provided at the cell holder to fix the first electrode tab 111A and the second electrode tab 111B, respectively. A detailed configuration of the secondary batteries is the same as the configuration described with reference to FIGS. 1 to 3, so that a detailed description thereof will not be repeated.

The secondary battery in the battery pack may include the cell holder 120 according to the exemplary embodiment in which the cell holder includes one holder frame, or the cell holder 120′ according to the exemplary embodiment in which the cell holder includes the plurality of holder frames. However, the connection parts 134 formed at the first and second clips 130A and 130B will be indicated by a bar contact part hereinafter, i.e., the connection part 134 formed at the first clip 130A will be indicated by a first bar contact part 135A.

In detail, referring to FIGS. 4-5, the plurality of conductive bars 140A and 140B are bar-shaped members for connecting the secondary batteries in parallel, and include a first conductive bar 140A for electrically connecting first electrodes and a second conductive bar 140B for electrically connecting second electrodes. The first conductive bar 140A and the second conductive bar 140B have a same shape but different targets for connection, so that the first conductive bar 140A will be described in detail below hereinafter. A configuration of the first conductive bar 140A is applied to the second conductive bar 140B as a matter of course.

As illustrated in FIG. 5, the first conductive bar 140A includes a plurality of clip contact parts 141A inserted into the plurality of first clips 130A, respectively, and a connection bar 145A for connecting the plurality of clip contact parts 141A with each other. Referring to FIG. 5, the connection bar 145A is a plate-shaped member extended in a direction crossing the plurality of first clips 130A from a side border of the first clip 130A.

Referring to FIGS. 5 and 6, the plurality of clip contact parts 141A is extended from the connection bar 145A to a space between a pair of extended parts 132 and 133, and is in contact with and fixed to the bar contact part 135A. In the first conductive bar 140A, the plurality of clip contact parts 141A is extended into the plurality of first clips 130A, respectively, from the connection bar 145, so that the first conductive bar 140A generally has an approximate comb shape. One end of the connection bar 145 is further extended to be electrically connected to a charge/discharge control circuit and additional configurations for controlling the secondary battery and supplying power to a load.

According to the aspect of the aforementioned configuration, the first conductive bar 140A has a structure in which the conductive bar is simply inserted into and fixed to the first and second clips 130A and 130B, so that it is possible to easily connect the secondary batteries in parallel, and easily change the number of secondary batteries connected.

FIG. 7 illustrates an embodiment of the unit cell, schematically illustrating an electrode assembly that is sealed in a pouch type case. Referring to FIG. 7, the electrode assembly 210 may be formed by stacking an anode plate, a separating plate and a cathode plate sequentially, and thereafter winding them.

The case 115 may be a member that surrounds the electrode assembly 210. The case 115 may include a first portion case 241 and a second portion case 242. A space for receiving the electrode assembly 110 may be formed in the first portion case 241. The second portion case 242 may cover the first portion case 241. The space for receiving the electrode assembly may correspond to a shape and a size of the electrode assembly. For example, but without limitation thereto, the space for receiving the electrode assembly may be made by a deep drawing process which is used for manufacturing a seamless hollow container on a flat board.

The unit cell 110 may be manufactured by providing the electrode assembly and the electrolyte in the space for receiving the electrode assembly and by forming a sealing portion 247 by thermal bonding edges 248 of the first portion case 241 and edges 246 of the second portion case 242 in a state where the first portion case 241 and the second portion case 242 are in close contact with each other. The electrode tabs 111A, 111B of the electrode assembly 210 may extend to outside of the battery case through the sealing portion 247.

The pair of electrode tabs 111A, 111B may further include films 214, 215, respectively, for insulation. The films 214, 215 may insulate between the pair of electrode tabs 111A, 111B and the case 115.

It has been described in detail that the electrode assembly of winding type is sealed in a pouch type case as an embodiment of the unit cell with reference to FIG. 7. However, the present invention is not limited thereto. A stack type electrode assembly may be sealed in a pouch type case or a stack or winding type electrode assembly may be sealed in an angular case.

By way of summation and review, a conventional battery pack includes a plurality of connected unit cells configured to have electrode terminals thereof connected by welding. However, such a connection structure is complex and may incur defects during welding.

In contrast, according to embodiments, a secondary battery is assembled by fixing an electrode tab of a unit cell without welding, so that a fixing structure is simple and poor welding may be prevented, thereby decreasing a defect rate while manufacturing the secondary battery. Further, the resultant structure, in which a plurality of secondary batteries is connected in parallel, is simple, and is easy to change, thereby simply manufacturing a battery pack in which the plurality of secondary batteries is connected.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a unit cell including a first electrode tab and a second electrode tab;
a cell holder accommodating the unit cell, the first electrode tab and the second electrode tab being exposed by the cell holder;
a first clip fixed to the cell holder, the first electrode tab being detachably inserted into the first clip; and
a second clip fixed to the cell holder, the second electrode tab being detachably inserted into the second clip.

2. The secondary battery as claimed in claim 1, wherein the unit cell includes:
an electrode assembly including a first electrode, a second electrode, and a separator interposed between the first electrode and the second electrode; and
a case accommodating the electrode assembly and an electrolyte,
wherein the first electrode tab is electrically connected with the first electrode and extended outside of the case, and
wherein the second electrode tab is electrically connected with the second electrode and extended outside of the case.

3. The secondary battery as claimed in claim 1, wherein the cell holder includes:
a holder frame surrounding a border of the unit cell; and
a clip fixing part extended from the holder frame, the first clip being fixed to a first side of the clip fixing part to face the first electrode tab, and the second clip being fixed to a second side of the clip fixing part to face the second electrode tab.

4. The secondary battery as claimed in claim 3, wherein each of the first electrode tab and the second electrode tab is extended outside of the holder frame, the first and second electrode tabs extending in a same direction as the clip fixing part.

5. The secondary battery as claimed in claim 4, wherein the first electrode tab and the second electrode tab are extended in a space between the first clip and the second clip.

6. The secondary battery as claimed in claim 4, wherein the first clip and the second clip are fixed to the clip fixing part while facing each other.

7. The secondary battery as claimed in claim 3, wherein:
the holder frame includes first and second frame parts coupled to each other,
the first frame part partially surrounds the unit cell and is extended from at least a first side adjacent to the first electrode tab to an opposite side of the first side, and
the second frame part partially surrounds the unit cell at the opposite side of the first frame part, and is extended from at least a second side adjacent to the second electrode tab to an opposite side of the second side.

8. The secondary battery as claimed in claim 7, wherein the clip fixing part includes:
a first clip fixing part extended from the first frame part, the first clip being fixed to the first clip fixing part; and
a second clip fixing part extended from the second frame, the second clip being fixed to the second clip fixing part.

9. A battery pack, comprising:
a plurality of secondary batteries; and
a plurality of conductive bars connecting the plurality of secondary batteries in parallel,
wherein each secondary battery includes:
a unit cell including a first electrode tab and a second electrode tab,
a cell holder accommodating the unit cell, the first electrode tab and the second electrode tab being exposed by the cell holder,
a first clip fixed to the cell holder, the first electrode tab being detachably inserted into the first clip, and
a second clip fixed to the cell holder, the second electrode tab being detachably inserted into the second clip.

10. The battery pack as claimed in claim 9, wherein each of the first clip and the second clip includes:
a bar contact part in contact with the conductive bars; and
a tab contact part bent and extended from the bar contact part, a corresponding electrode tab, between the first electrode tab and the second electrode tab, being inserted into the tab contact part,
wherein the tab contact part includes a pair of extended parts having a gradually decreasing interval therebetween, and then having a gradually increasing interval therebetween, the corresponding electrode tab being fixed between the pair of extended parts.

11. The battery pack as claimed in claim 10, wherein the conductive bar includes:
a plurality of clip contact parts accommodated in corresponding bar contact parts among the plurality of bar contact parts; and
a connection bar electrically connecting the plurality of clip contact parts.

12. The battery pack as claimed in claim 11, wherein the connection bar is extended in a direction crossing the plurality of bar contact parts, and
each clip contact part is extended from the connection bar onto the bar contact part.

13. The battery pack as claimed in claim 10, wherein the tab contact parts of the first clip and the second clip face each other.

14. The battery pack as claimed in claim 13, wherein the cell holder includes a first holder part fixed to the first clip, and a second holder part fixed to the second clip.

15. The battery pack as claimed in claim 14, wherein:
the first holder part includes a first frame part partially surrounding the unit cell and extended from at least a first side adjacent to the first electrode tab to an opposite side of the first side, and
the second holder part includes a second frame part partially surrounding the unit cell at an opposite side of the first frame part, and extended from at least a second side adjacent to the second electrode tab to an opposite side of the second side.

16. A cell holder accommodating a unit cell of a secondary battery, the cell holder comprising:
a first clip extending from a frame, a first electrode tab of the unit cell being detachably inserted into the first clip; and
a second clip extending from the frame, a second electrode tab of the unit cell being detachably inserted into the second clip.
